(19) United States
(12) Patent Application Publication
(10) Pub. No.: US 2006/0164411 A1
(43) Pub. Date: Jul. 27, 2006

(54) Systems and methods for displaying multiple views of a single 3D rendering ("multiple views")

(75) Inventor: Eugene C. K. Lee, Singapore (SG)

Correspondence Address: KRAMER LEVIN NAFTALIS & FRANKEL LLP, INTELLECTUAL PROPERTY DEPARTMENT, 1177 AVENUE OF THE AMERICAS, NEW YORK, NY, 10036, US

(73) Assignee: Bracco Imaging, s.p.a., Milano (IT)

(21) Appl. No.: 11/288,876

(22) Filed: Nov. 28, 2005

Related U.S. Application Data
(60) Provisional application No. 60/631,196, filed on Nov. 27, 2004.
(60) Provisional application No. 60/740,221, filed on Nov. 26, 2005.

(51) Int. Cl. G06T 15/00

(52) U.S. Cl. 345/419

(57) ABSTRACT

Systems and methods are presented for substantially simultaneously displaying two or more views of a 3D rendering. Such methods include generating a stereo pair of projections from a 3D model, receiving display mode information, processing the stereo pair of projections in accordance with the display mode information to create output data streams, and distributing each data streams to an appropriate display device. In exemplary embodiments of the present invention such methods can be implemented using a rendering engine, a post-scene processor communicably connected to the rendering engine, a scene distributor communicably connected to the post-scene processor, and one or more display devices communicably connected to the post-scene processor, wherein in operation the rendering engine generates 2D projections of a 3D model and the post-scene processor processes said projections for display in various formats. In exemplary embodiments of the present invention two views of a 3D rendering can each be stereoscopic, and they can be flipped relative to one another. In exemplary embodiments of the present invention one of the relatively flipped views can be displayed at an interaction console and the other at an adjacent desktop console.

### CROSS-REFERENCE TO RELATED APPLICATIONS

This application claims the benefit of U.S. Provisional Patent Applications Nos. 60/631,196, filed on Nov. 27, 2004, and United States Provisional Patent Application No. ______, filed on Nov. 26, 2005, entitled “SYSTEMS AND METHODS FOR DISPLAYING MULTIPLE VIEWS OF A SINGLE 3D RENDERING AND FOR BACKDROP RENDERING”, Inventor Eugene C. K. Lee, of Singapore (serial number not yet known, applicant reserves the right to amend this disclosure to provide it when available). The disclosures of each of these provisional patent applications are hereby incorporated herein by reference as if fully set forth.

### TECHNICAL FIELD

The present invention is directed to interactive 3D visualization systems, and more particularly to systems and methods for displaying multiple views in real-time from a single 3D rendering.

### BACKGROUND OF THE INVENTION

Volume rendering allows a user to interactively visualize a 3-D data set such as, for example, a 3-D model of a portion of the human body created from hundreds of imaging scan slices. In such 3-D interactive visualization systems, a user is free to travel through the model, interact with as well as manipulate it. Such manipulations are often controlled by handheld devices which allow a user to “grab” a portion of the 3-D Data Set, such as, for example, that associated with a real life human organ, such as the liver, heart or brain, and for example, to translate, rotate, modify, drill, and/or add surgical planning data to, the object. Because of the facilities for such hands-on interactivity in such systems, users tend to desire a “reach-in” type of interaction, wherein the motions that their hands are implementing to control the handheld interfaces in some way feel as if they were actually reaching in to a three dimensional body and physically manipulating the organs that they are visualizing.

FIG. 1 illustrates this type of interaction. At 110, there is seen a three dimensional image displayed on a monitor. A user desires to “reach in” to manipulate it, but, of course, is precluded from doing so by the front surface of the display screen.

In order to solve this problem, some interactive 3-D visualization systems have projected the display image on to a mirror. Such a solution has been implemented in the Dextroscope™ developed by Volume Interactions Pte Ltd. of Singapore. Such a solution is depicted in FIG. 1 at 120 and 130. With reference thereto, 120 depicts a user visualizing an image via a mirror which reflects it from a display monitor mounted above it. The mirror is at approximately the same position as the user's torso and head when seated. By looking at the reflected image, a user can place his hands behind the mirror and thereby have a simulated “reach-in” type interaction with the displayed 3-D model. While this solution works well for a single user, often in visualizing three dimensional data sets there is one user who is manipulating the data and one or more colleagues of said user standing by and watching the manipulations. This is common, for example, in teaching contexts, as well as in collaborative efforts to solve difficult surgical planning problems where a lead surgeon may ask a visualization specialist to sit at the console and manipulate a 3D data set to visualize the consequences of various surgical approaches.

When there are multiple parties attempting to view a data set being manipulated the mirror solution described above reaches its limits. This is because in order to accurately project the image onto the mirror in such a way that it appears in the same orientation as if a user was seated directly in front of the display monitor, as shown in 110, the image must be flipped in the monitor such that the reflection of the flipped image is once again the proper orientation. Thus to allow the view displayed in monitor 110 and in mirror 120 to be of the same orientation, the monitor which is reflected by mirror 120 must project an inverted, or flipped image such that once reflected in mirror 120 it can be the same view as the non-flipped image shown in 110.

View 130, with reference to FIG. 1, illustrates the problem with this technique. Interaction Console 101 shows the reflection of the actual image displayed by the monitor. The reflection is in the proper orientation. Therefore, the Desktop auxiliary monitor 102 shows the same image as is displayed by the monitor situated in the upper portion of Interaction Console 101. As can be seen, the image in the Desktop monitor 102 is flipped relative to that seen in the Interaction Console 101's mirror which results in a non-informative and non-interactive Desktop workspace for anyone looking on.

In order to solve this problem both Interaction Console 101 and the Desktop monitor 102 would need to display the same orientation. What makes the problem more egregious is that some interactive 3-D visualization systems utilize a stereoscopic projection of the visualized model to provide a user with depth cues. The use of stereoscopic visualization increases a user's sense of actually manipulating a 3-D model and thereby also exacerbates a user's intuitive need for a “reach-in” type interaction. However, for those viewing on a Desktop monitor it is often more difficult to visually reconcile a stereoscopic picture presented upside down, than it is to follow a monoscopic image that is displayed upside down. Thus, the technological benefit also exacerbates the flipped screen problem by increasing the discrepancy in utility between the flipped images. Moreover, it is not possible to simply use a VGA video splitter to solve this problem. Normal VGA video splitters simply duplicate an incoming signal. They cannot perform sophisticated signal manipulations such as, for example, mirroring in one or more axes. Moreover, the signal quality gets poorer with every video split.

Alternatively, there are more sophisticated video converters that can flip in one axis, such as, for example, those utilized in teleprompter systems, but they are limited in both vertical frequencies and screen resolutions that are supported. In general, the maximum supported vertical frequency is 85 Hz. Unfortunately, stereo scenes need to be viewed at a vertical frequency of 90 Hz or greater to avoid flicker.

Vertical frequency or more commonly known as the refresh rate is measured in Hertz(Hz). It represents the number of frames displayed on the screen per second. Flickering occurs when there is significant delay in transition from one frame to the next and this interval becomes perceivable to the human eye. A person's sensitivity to flicker varies with image brightness but on the average, the perception of flicker drops to an acceptable level when it is 40 Hz and above. The optimal refresh rate per eye is 50-60 Hz. Hence, for stereo viewing the refresh rate should be at least 50×2=100 Hz.

Sophisticated video converters are limited in vertical frequency due to the demand. There is no demand for higher refresh rate as the inputs to these converters that possess flipping functions have refresh rates less than or equal to 85 Hz. Teleprompters (See below) do not need stereoscopic visualization. They display words to prompt a newscaster. An example of a teleprompter system is provided in FIG. 1A where it can be seen that the screen is flipped vertically (about the x axis).

Other potential solutions to this problem could include sending stereo VGA signal to an active stereo projector capable of flipping the scene in either the X or Y axis and piping the signal back to a monitor or projecting it onto a screen. Such projectors are either expensive (and generally cumbersome) or limited in native resolution (for example, that of the Infocus DepthQ projector of only 800×600).

Theoretically one could custom-make a video converter that can flip an input stereo VGA signal of up to 120 Hz and output at the same frequency, but such a custom made solution would be expensive and thus impractical.

Given that the above-described possible solutions are by and large either impractical, cumbersome and/or prohibitively expensive, what is needed in the art is a way to display multiple views of the same 3D rendering in real time such that each of the different views can satisfy different display parameters and user needs.

### BRIEF DESCRIPTION OF THE DRAWINGS

FIG. 1 illustrates viewing of a rendered image on conventional displays, mirror projected displays, and combinations thereof where the images are flipped relative to one another;

FIG. 1A illustrates reflection of a displayed image about an axis;

FIG. 2 depicts the physical set up of the combination of FIG. 1 with multiple views displayed in the same orientation according to exemplary embodiments of the present invention;

FIG. 3 is an exemplary system level view according to exemplary embodiments of the present invention;

FIG. 4 is a process flow diagram system according to exemplary embodiments of the present invention;

FIG. 4A illustrates generating a 2D projection of a 3D object;

FIG. 4B depicts an example of vertical interlacing;

FIG. 5 depicts an exemplary implementation according to exemplary embodiments of the present invention;

FIG. 6 illustrates the set up and division of a screened area according to exemplary embodiments of the present invention; and

FIG. 7 depicts an exemplary orthogonal projection.

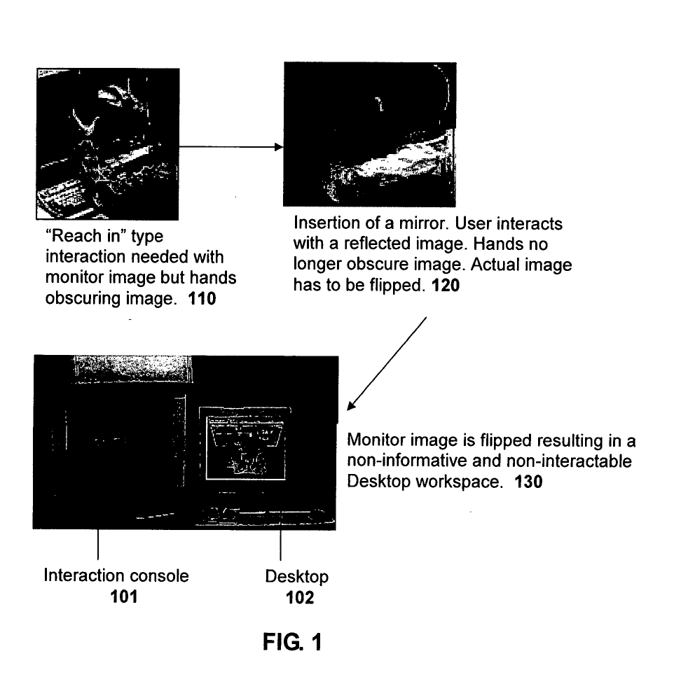

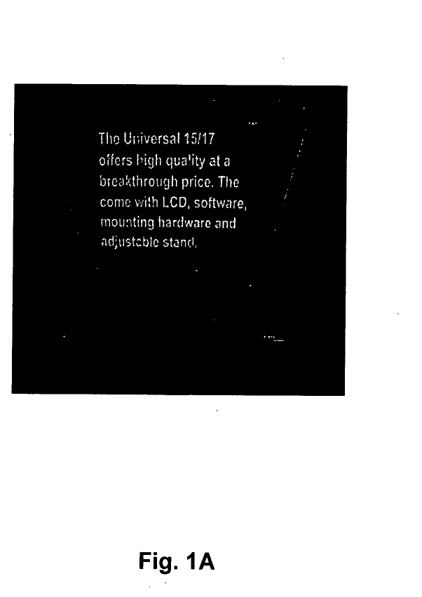

It is noted that the patent or application file contains at least one drawing executed in color. Copies of this patent or patent application publication with color drawings will be provided by the U.S. Patent Office upon request and payment of the necessary fees.

It is also noted that some readers may only have available greyscale versions of the drawings. Accordingly, in order to describe the original context as fully as possible, references to colors in the drawings will be provided with additional description to indicate what element or structure is being described.

### SUMMARY OF THE INVENTION

Systems and methods are presented for substantially simultaneously displaying two or more views of a 3D rendering. Such methods include generating a stereo pair of projections from a 3D model, receiving display mode information, processing the stereo pair of projections in accordance with the display mode information to create output data streams, and distributing each data streams to an appropriate display device. In exemplary embodiments of the present invention such methods can be implemented using a rendering engine, a post-scene processor communicably connected to the rendering engine, a scene distributor communicably connected to the post-scene processor, and one or more display devices communicably connected to the post-scene processor, wherein in operation the rendering engine generates 2D projections of a 3D model and the post-scene processor processes said projections for display in various formats. In exemplary embodiments of the present invention two views of a 3D rendering can each be stereoscopic, and they can be flipped relative to one another. In exemplary embodiments of the present invention one of the relatively flipped views can be displayed at an interaction console and the other at an adjacent desktop console.

### DETAILED DESCRIPTION OF THE INVENTION

In exemplary embodiments of the present invention systems and methods can be provided such that both an Interaction console display and an auxiliary Desktop display can be seen by users in the same orientation, thus preserving real-time rendering and interaction in full 3D stereoscopic mode.

In exemplary embodiments of the present invention multiple views can be provided where each of 3D stereoscopic scenes and real-time rendering and interactivity is preserved. Moreover, such exemplary systems are non-cumbersome, easy to deploy and relatively inexpensive.

In exemplary embodiments of the present invention systems for creating multiple views (independently monoscopic and/or stereoscopic) in real-time from a single rendering (3D or 2D) can be provided. Such views can have optional post processing and display optimizations to allow outputting of relatively flipped images where appropriate.

In exemplary embodiments of the present invention 3D stereoscopic scenes can be preserved and undistorted, systems can be interacted with in real-time without delay, and cumbersome equipment is not required to achieve such functionality. Moreover, because no customized converter is needed, such implementations are economical.

In exemplary embodiments of the present invention stereo image pairs can be post-processed according to user needs, and thus stereo pairs can be flipped vertically or horizontally accordingly. Both monoscopic and stereoscopic modes can be supported simultaneously, and hybrids of stereoscopic modes (page-flipping, anaglyph, autostereoscopic etc) can be simultaneously supported in one system.

Moreover, stereo pairs can be sent across data networks to thin clients and presented in alternative stereoscopic modes. Exemplary systems according to the present invention can thus open up to possibilities of interaction on both Desktop and Interaction consoles, inasmuch as once the Desktop image is displayed in the correct orientation, an application can be created wherein one user can, for example, interact with objects in the Dextroscope™ (described below—an exemplary 3D interactive visualization system) and another user can interact with the same 3D model via the Desktop image, using for example, a mouse or other alternative input device. This represents a significant improvement over a Desktop user acting as a pure viewer without interaction.

System Flexibility Overview

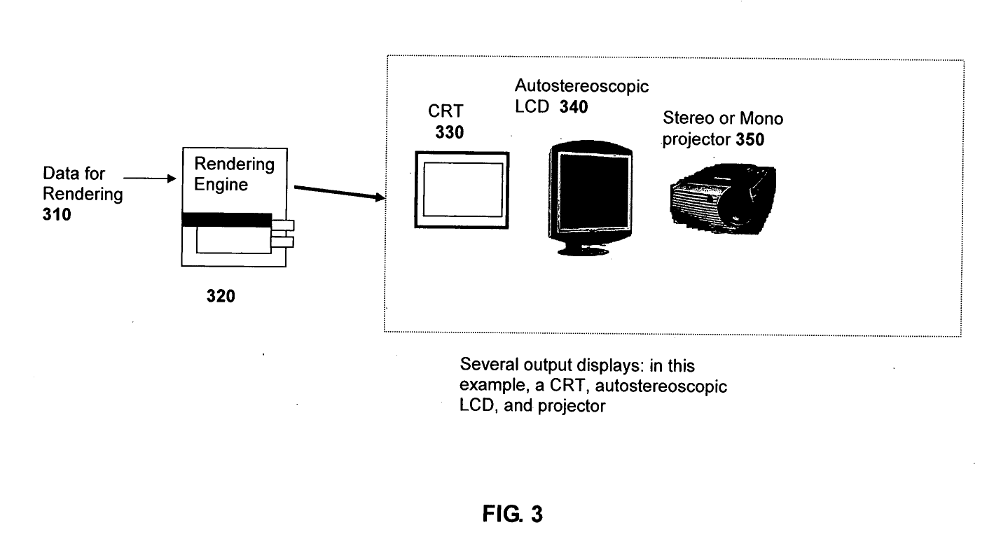

FIG. 3 is an exemplary system level diagram according to exemplary embodiments of the present invention. In operation, data flows from the left of the figure to the right.

With reference to FIG. 3, at 310 data for rendering can be input to the rendering engine 320. From the rendering engine 320 multiple display outputs can be provided, such as, for example, a CRT 330, an autostereoscopic liquid crystal display 340, and a stereoscopic or monoscopic projector 350. Thus, in exemplary embodiments of the present invention, a data set can be rendered once and displayed simultaneously in multiple displays each having its own set of display parameters.

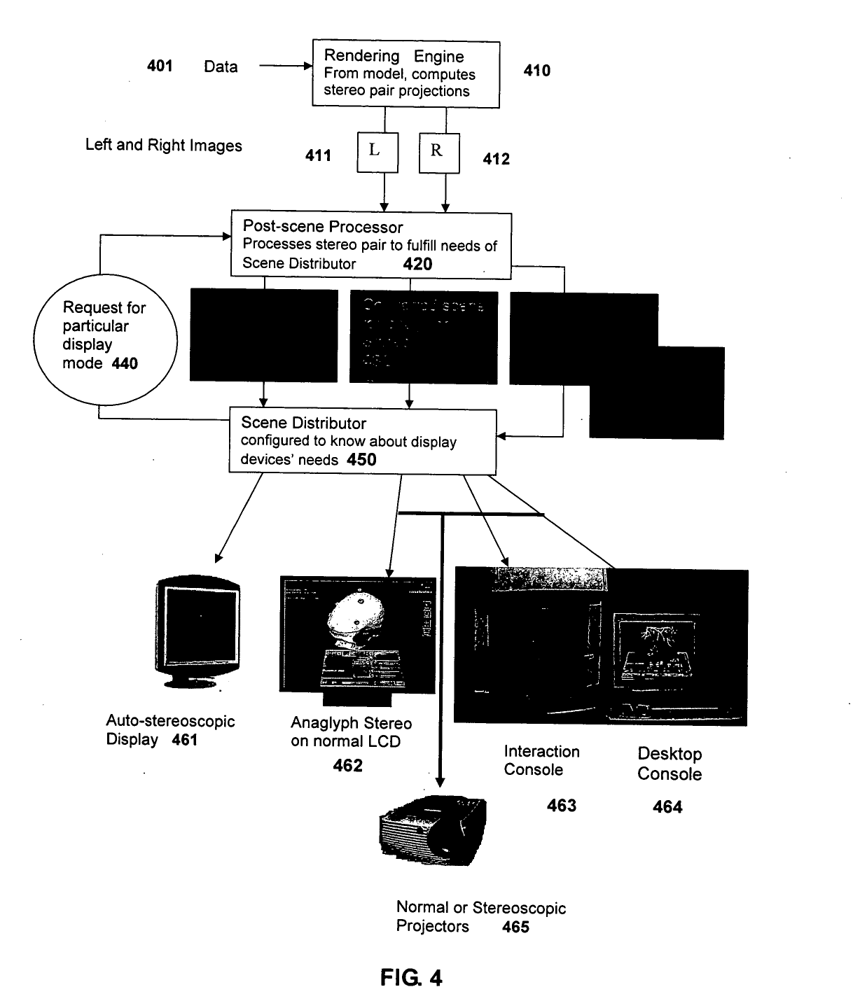

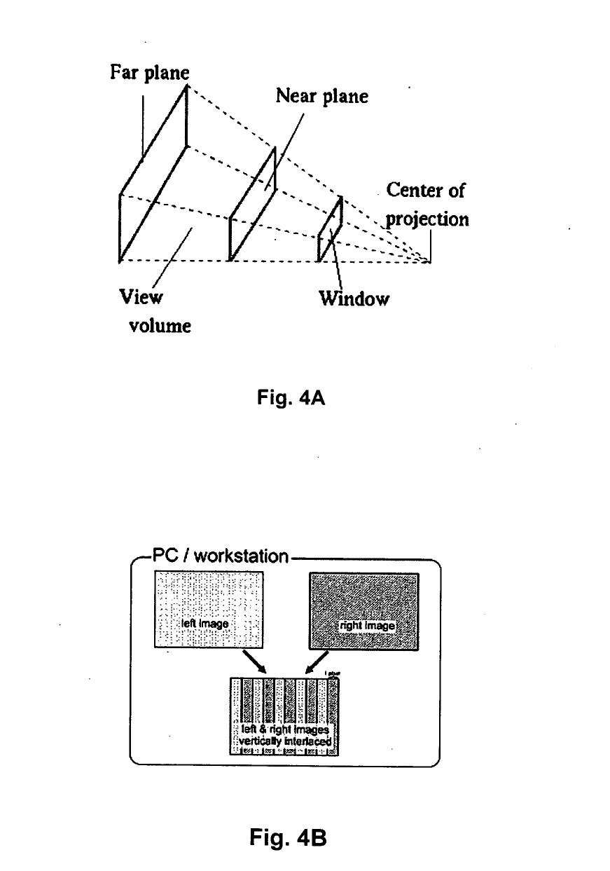

FIG. 4 is a process flow diagram according to exemplary embodiments of the present invention. Beginning at 401 data enters rendering engine 410 which can, for example, compute a stereo pair of projections from a model.

As is known, the human eyes, which are located approximately 6-7 cm apart, provide the brain with two slightly different images of a scene. Thus, a stereo pair consists of two images of a scene from two different viewpoints. The brain fuses the stereo pair to obtain a sense of depth, resulting in a perception of stereo.

Projection is the process of mapping the 3D world and thus objects within it, onto a 2D image. In perspective projection imaginary rays coming from the 3D world pass through a viewpoint and map onto a 2D projection plane. This is analogous to the pin-hole camera model shown, for example, in FIG. 4A. Each eye would have a different projection since it is looking from a slightly different viewpoint.

Having computed the stereo pair of projections, rendering engine 410 outputs the left and right images L 411 and R 412, respectively. Each of the left and right images 411, 412 can be input into a post-scene processor 420 which can, for example, process the stereo pair of images to fulfill the needs of various users as stored in scene distributor 450.

From post-scene processor 420, there can be output, for example, multiple data streams each of which involves processing the stereo pair of images in different ways. For example, at 431 a vertical or interlaced scene of the left and right images can be output to the scene distributor. Similarly, the stereo pair of images can be converted to color anaglyphic stereo at 432 and output to the scene distributor. Finally, for example, at 433 a flipped scene can be output for use and at 434 the same scene as sent in 433 can be output as well except for the fact that it is not flipped.

Thus, as shown in FIG. 4, the following exemplary outputs can be generated at the post-scene processor:

431—Vertical interlacing of Left and Right. This is the format that autosterescopic monitors based on lenticular technology, as depicted in FIG. 4B can accept to achieve the stereoscopic effect.

432—Anaglyphic Stereo. The final image is RGB. The information in the left view is encoded in the red channel and the information in the right view is encoded in the green and blue channels. When red-cyan/red-green glasses are worn, a stereo effect is achieved as the left eye (with red filter) sees the information encoded in the red channel and the right eye (with cyan filter) sees that of that right view. Anaglyphic stereo is commonly used in 3D movies.

433 and 434—Pageflipping stereo. This is where the left and right channels are presented in alternate frames. For example, the Dextroscope™ can use either pageflipping stereo or vertical interlacing stereo. Both types of stereo require shutter glasses. The vertical interlacing pattern is similar to that used in FIG. 4A but there is no lenticular technology involved. Vertical interlacing sacrifices half the horizontal resolution to achieve stereo. On the other hand, pageflipping provides full screen resolution to both eyes. Thus pageflipping provides better stereo quality.

The major difference between the exemplary stereoscopic output formats described above is that 431 does not require glasses for viewing by a user, 432 requires red-cyan/red-green glasses and 433 and 434 require shutter glasses.

Given the various outputs 431 through 434 of the same stereo pair of images, the scene distributor 450, having been configured as to the needs of the various display devices connected to it, can send the appropriate input 431 through 434 to an appropriate display device 461 through 464. Thus, for example, the vertical interlaced scene of left and right images 431 can be sent by the scene distributor 450 to an autostereoscopic display 461. Similary, the converted scene for anaglyphic stereo 432 can be sent by the scene distributor 450 to LCD 462. Finally, output streams 433 and 434, being flipped and unflipped data streams, respectively, can be sent to a Dextroscope™ type device where the flip datastream can be projected onto a mirror in an Interaction console 463 and the unflipped data stream can be sent to an auxiliary Desktop console 464 for viewing by colleagues of a user seated at the Interaction console. Finally, either the anaglyphic data stream 432 or the unflipped data stream 434 can be alternatively sent to a normal or stereoscopic projector 465 for viewing by a plurality of persons.

Example Implementation Using Nvidia Quadro FX Card Equipped Workstation

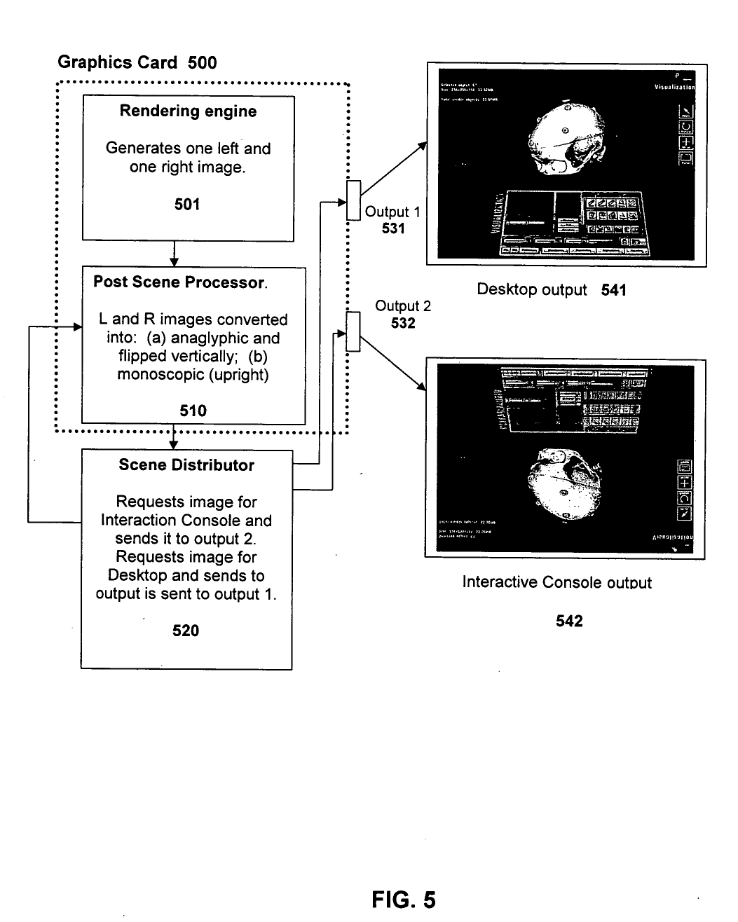

FIG. 5 depicts an exemplary implementation according to an exemplary embodiment of the present invention involving one single rendering that is sent to two different display outputs. One of the display outputs 541 is monoscopic and upright, i.e., not flipped, and the other is stereoscopic using anaglyphic red-blue stereoscopic display. The depicted implementation can be used, for example, with a workstation having an Nvidia Quadro FX graphics card.

With reference to FIG. 5, the figure illustrates processing that occurs within the graphics card 500 and the scene distributor 520 and which results in the two outputs 541 and 542.

Within the graphics card 500 there is a rendering engine 501 and a post-scene processor 510. The rendering engine 501 generates one left and one right image from the input data. Such input data was shown, for example, with reference to FIG. 4 at 401 and with reference to FIG. 3 at 310. The left and right images can be, for example, output by the rendering engine to the post scene processor as depicted and described in connection with FIG. 4, and thus the left and right images can be converted into each of (a) an anaglyphic and vertically flipped and (b) a monoscopic (upright) data stream.

These two data streams can, for example, be output from the graphics card to a scene distributor which runs outside the graphics card, and which can receive the processed stereo pair of images and then send them back to the graphics card to be output via an appropriate display output. Thus, for example, the scene distributor 520 can request the image for the interaction console output, namely the anaglyphic and vertically flipped data stream, and send it via output port 532 to interaction console output 542. Similarly, the scene distributor 520 can request the image for the desktop output 541, namely the monoscopic upright image, and send it via output port 531 to desktop output 541.

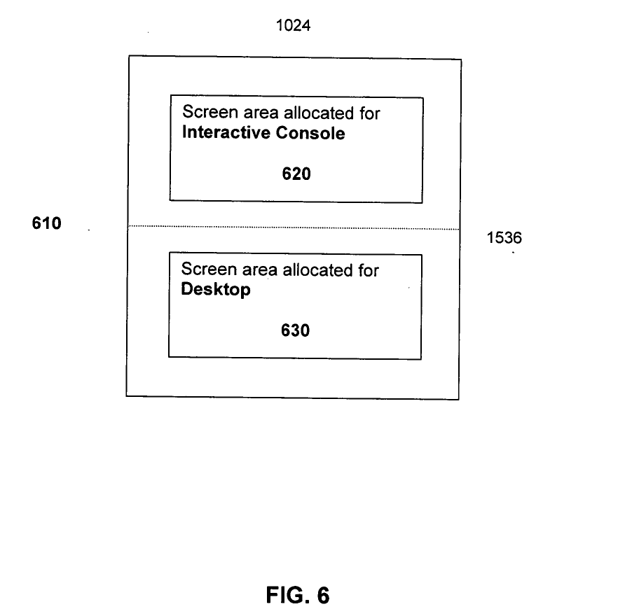

FIG. 6 illustrates how a 1024×1536 screen area can be allocated to two different views, each used to generate one of the views, according to an exemplary two-view embodiment of the present invention. Here, for example, screen area 610 can be divided into two 1024×768 resolution sub screen areas, one 620 used to generate a flipped image for display via a mirror in an interaction console, the other 630 used to generate a vertical image for display in a desktop monitor.

It is noted that while FIG. 4 shows various possible output data streams, these need not be all supported simultaneously. Three or four views would be possible with more display channel inputs on the graphics card. Currently, however, graphics cards generally have only two display channel inputs.

Thus, with a two channel graphics card, an exemplary system can have the following sets of output datastreams:

Interaction Console—pageflipping/active stereo;

Desktop Console—monoscopic.

Interaction Console—pageflipping/active stereo;

Desktop Console—anaglyph stereo.

Interaction Console—anaglyph stereo;

Desktop Console—pageflipping/active stereo.

Interaction Console—anaglyph stereo;

Desktop Console—monoscopic.

It is noted that FIG. 6 corresponds to two output data streams, for example, one flipped and the other unflipped. In order to accommodate more output data streams than two, more screen area could be utilized. However, this is useful only if the desired screen resolution can be supported at the refresh rate that is required for stereo viewing. Thus, it is not just the memory in the video card that is a factor, but it is also a matter of the support of the video card for the configuration and whether the display output devices (monitors, projectors) can support the configuration. There are limits to the screen resolution a video card supports and the refresh rate also plays a big part. For example, 2048×2048 at 120 Hz would probably not be practical given current technology.

Exemplary Implementation on a 3D Interactive Visualization System Equipped with an Nvidia Quadro FX Card Using one Stereo Pair:

Initialization

1. Setup a suitable screen area which is spans vertically as shown (not restricted to vertical span. Can be horizontal span or other combinations). Example is a 1024×1536@120 Hz desktop;
2. Create offscreen pixel buffers one for left image and one for right image;
3. Set up offscreen pixel buffers to be bounded as 2D texture images; and
4. Create Windows for both Desktop and Interaction Console.

It is noted that Bounded as 2D texture images refers to the modern graphics card capabilities. In the past, to do offscreen rendering, it was generally necessary to bind the offscreen rendering as a 2D texture (slow process) before using it in the framebuffer. A modern graphics card allows an offscreen pixel buffer to be allocated in the framebuffer in a format that is immediately suitable to be used as a 2D texture. Since it is already resident in the framebuffer memory, this eliminates the need to shift from main memory to graphics memory, which can be slow.

Rendering for Left and Right Images (in Rendering Engine)

1. Activate pixel buffer for left eye;
2. Set up projection matrix for left eye;
3. Set up modelview matrix for left eye;
4. Render scene for left eye to pixelbuffer;
5. Activate pixel buffer for right eye;
6. Set up projection matrix for right eye;
7. Set up modelview matrix for right eye;
8. Render scene for right eye to pixelbuffer;
9. Send both left and right images to Post Processor for image manipulation (flipping images/grayscale conversion etc);
10. Pass final images to Scene distributor; and
11. Output to display outputs.

As is illustrated in FIG. 4A, a projection matrix is a 4×4 matrix with which a 3D scene can be mapped onto a 2D projection plane for an eye. That is why there is a projection matrix for each of the left and right eyes (see 2 and 3, above). A ModelView matrix (see 3 and 7) transforms a 3D scene to the viewing space/eye space. In this space, the viewpoint is location at 0,0,0 the origin.

Exemplary Pseudocode for Display of One Complete Stereo Scene (Left and Right)

In exemplary embodiments of the present invention the following exemplary pseudocode can be used to implement the display of a complete stereo scene.

// Display Loop for Interaction console window.
Foreach Display frame do
{

switch (DisplayMode)
{

// see Display Sub-routines
case pageflipping stereo : DisplayStereoPageFlipping
case red green stereo : DisplayStereoRedGreen
case mono : DisplayStereoMono

}

}
// Display Loop Desktop Window.
Foreach Display frame do
{

Set up orthogonal projection
switch (DisplayMode)
{

case pageflipping stereo : PasteTextureStereoPageFlipping
(mirror yes)
case red green stereo : PasteTextureStereoRedGreen
(mirror yes)
case mono : PasteTextureMono (mirror yes)

}

}

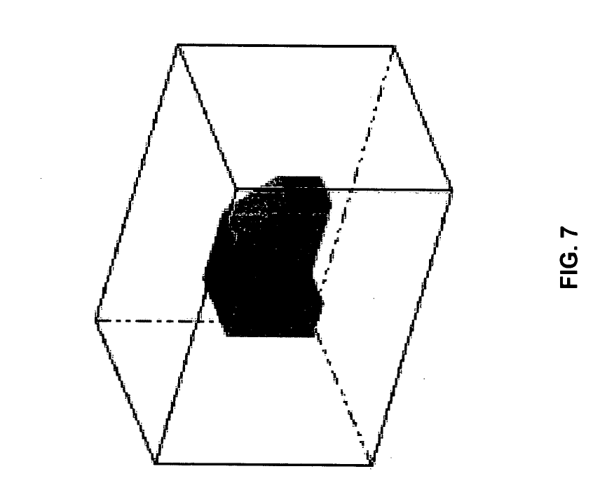

Here orthogonal projection refers to a means of representing a 3D object in two dimensions. It uses multiple views of the object, from points of view rotated about the object's center through increments of 90°. Equivalently, the views may be considered to be obtained by rotating the object about its center through increments of 90°. It does not give a viewer a sense of depth. The viewing volume is as shown in FIG. 7, without perspective. Although 3D interactive visualization systems generally utilize essentially perspective projection, an orthographic projection is simply set up here so that a texture image can be pasted flat on a screen.

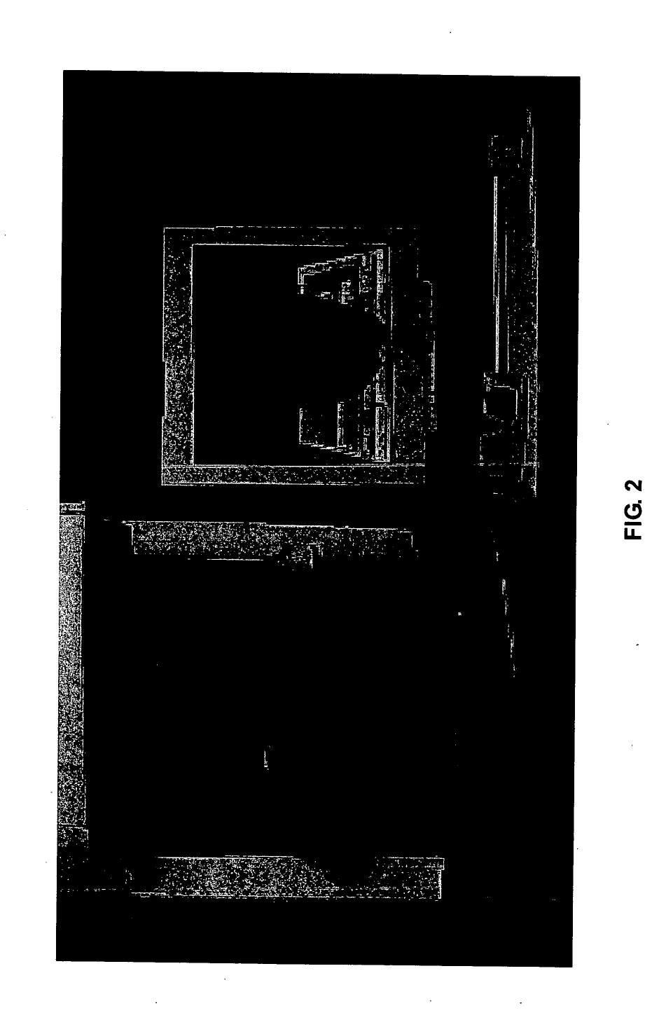

mirror yes refers to an indication that flipping of the image is desired. In the exemplary implementation shown in FIGS. 2 and 433, 434 of FIG. 4. the Interaction Console image is the primary image rendered, so the image for the Desktop Console is the one that is actually flipped.

// Display Sub-routines
DisplayMono
{

foreach eye [ left]
{

| SetCurrentBuffer(pixelbuffer[eye]) | |
|---|---|
| SetProjectionMatrix(eye) | |
| SetModelViewMatrix(eye) | |
| RenderScene(eye) | |
| SetCurrentBuffer(framebuffer) | |
| Set Orthogonal projection. | |
| Bind pixelbuffer[eye] as texture | |
| PasteTextureMono(mirror no) | // mirror no == not to flip |
| Release pixelbuffer[eye] as texture. | |

}

}

It is noted that in the above exemplary pseudocode the Framebuffer refers to a memory space in the video card that is allocated for performing graphics rendering. Pixelbuffer refers to the offscreen area and is not meant for display on the screen. Current Buffer specifies the target buffer that subsequent drawing commands should affect. The flow is as follows; the Pixelbuffer is made the Current Buffer and the scene is rendered into this buffer which is not visible on screen. Next the Framebuffer is made the Current Buffer, and the pixelbuffer is used as a texture to paste into the Framebuffer. What is subsequently shown on the screen thus comes from the Framebuffer.

DisplayStereoRedGreen

{

SetCurrentBuffer(pixelbuffer[left])
foreach eye [ left, right]
{

SetProjectionMatrix(eye)
SetModelViewMatrix(eye)
RenderScene(eye)

}
SetCurrentBuffer(framebuffer)
Set Orthogonal projection.
Bind pixelbuffer[left] as texture
Convert texture to grayscale.
PasteTextureMono(mirror no)
Release pixelbuffer[left] as texture.

}

DisplayStereoPageFlipping

{

foreach eye [ left, right]
{

SetCurrentBuffer(pixelbuffer[eye])
RenderScene(eye)
SetCurrentBuffer(framebuffer[eye])
Set Orthogonal projection.
Bind pixelbuffer[eye] as texture
PasteTextureStereoPageFlipping(mirror no)
Release pixelbuffer[eye] as texture.

}

}

It is noted that the present invention achieves a solution that solves the fundamental objective of seeing a desktop monitor image in correct orientation and in stereo, as shown in FIG. 2. In developing this solution it was seen that a software solution would be practical. Given the hardware capabilities of common graphics cards it was noted that rendering to texture could be a plausible solution as it is then not necessary to render the scene twice. Furthermore, such textures opened up flexibilities of multiple stereoscopic modes, as described above.

Thus, to solve the problems in the prior art it was necessary to draw two images to two different monitors in software. This resulted in allocating a logical screen area that spans two monitors. If vertical span is chosen (although in exemplary embodiments of the present invention horizontal span can also be chosen) the flexibility of using a mid-range LCD monitor for a Desktop console is facilitated. A CRT+LCD combination is possible at 1024×1536(768+768)@ 120 hz (vertical span) but perhaps not possible using 2048×768@120 hz(horizontal span). A more expensive high-end LCD monitor would be required for the horizontal span combination, which may be desirable in alternate exemplary embodiments.

In exemplary embodiments of the present invention, because more work is being done extra work (i.e., both in software as well as in hardware(graphics card)) it may be desirable to optimize rendering speed using known techniques.

Exemplary Systems

The present invention can be implemented in software run on a data processor, in hardware in one or more dedicated chips, or in any combination of the above. Exemplary systems can include, for example, a stereoscopic display, a data processor, one or more interfaces to which are mapped interactive display control commands and functionalities, one or more memories or storage devices, and graphics processors and associated systems. For example, the Dextroscope™ and Dextrobeam™ systems manufactured by Volume Interactions Pte Ltd of Singapore, running the RadioDexter™ software, or any similar or functionally equivalent 3D data set interactive visualization systems, are systems on which the methods of the present invention can easily be implemented. Exemplary embodiments of the present invention can be implemented as a modular software program of instructions which may be executed by an appropriate data processor, as is or may be known in the art, to implement a preferred exemplary embodiment of the present invention. The exemplary software program may be stored, for example, on a hard drive, flash memory, memory stick, optical storage medium, or other data storage devices as are known or may be known in the art. When such a program is accessed by the CPU of an appropriate data processor and run, it can perform, in exemplary embodiments of the present invention, methods as described above of displaying a 3D computer model or models of a tube-like structure in a 3D data display system.

While the present invention has been described with reference to one or more exemplary embodiments thereof, it is not to be limited thereto and the appended claims are intended to be construed to encompass not only the specific forms and variants of the invention shown, but to further encompass such as may be devised by those skilled in the art without departing from the true scope of the invention.

What is claimed:

1. A method of substantially simultaneously displaying two or more views of a 3D rendering, comprising:
generating a stereo pair of projections from a 3D model;
receiving display mode information;
processing the stereo pair of projections in accordance with the display mode information to create output data streams;
distributing each data streams to an appropriate display device.

2. The method of claim 1, wherein the display modes include at least two of auto-stereoscopic display, anaglyphic stereo display, display to reflection device, display to stereoscopic monitor.

3. The method of claim 1, wherein the display mode information is stored in a scene distributor, which, in operation, sends display mode requests to a post-scene processor.

4. The method of claim 1, wherein said output data streams include vertically interlaced left and right channels, anaglyphic stereo, and page-flipping stereo.

5. A system for substantially simultaneously displaying two or more views of a 3D rendering, comprising:
a rendering engine;
a post-scene processor communicably connected to the rendering engine;
a scene distributor communicably connected to the post-scene processor; and
one or more display devices communicably connected to the post-scene processor,
wherein in operation the rendering engine generates 2D projections of a 3D model and the post-scene processor processes said projections for display in various formats.

6. The system of claim 5, wherein the rendering engine generates a pair of stereoscopic projections for stereo display.

7. The system of claim 5, wherein the scene distributor can be configured to store display parameters associated with each view.

8. The system of claim 5, wherein the scene distributor requests datastreams from the post-scene processor in conformity with the needs of the one or more display devices.

9. A method of displaying multiple views of one volume rendering, comprising:
dividing screen memory into multiple equal areas;
assign each area to one image;
assign each image to one display device;
processing each image according to a defined set of display parameters;
and displaying each image form its assigned screen memory to its associated display device.

10. The method of claim 9, wherein there are two views of the volume rendering.

11. The method of claim 10, wherein the two views are each stereoscopic, one flipped for display to a mirror and the other unflipped for display to a monitor.

12. The method of claim 11, wherein a flipped datastream is sent to an interaction console and an unflipped datastream to a desktop console adjacent to the interaction console.

13. A computer program product comprising a computer usable medium having computer readable program code means embodied therein, the computer readable program code means in said computer program product comprising means for causing a computer to:
generate a stereo pair of projections from a 3D model;
receive display mode information;
process the stereo pair of projections in accordance with the display mode information to create output data streams;
distribute each data stream .to an appropriate display device.
